(19) United States
(12) Patent Application Publication
(10) Pub. No.: US 2004/0109034 A1
(43) Pub. Date: Jun. 10, 2004

(54) Hybrid printing/pointing device

(75) Inventor: Patrick Brouhon, Saint Martin d'Uriage (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, LP.

(21) Appl. No.: 10/686,726

(22) Filed: Oct. 17, 2003

(30) Foreign Application Priority Data
Oct. 18, 2002 (EP) 02354163.4

(51) Int. Cl. B41J 3/36

(52) U.S. Cl. 346/143; 347/109

(57) ABSTRACT

A hybrid printing device for printing on a surface, the device comprising a printing means adapted to print on the surface and a sensing means adapted to sense the position of the printing device in relation to positioning indicia located on the surface wherein the printing means is further adapted to be responsive to the detected position of the device in relation to the detected position. The device operates by detecting the position whereby a print control means responds and signals to the printing head to function to build the image on the printing surface. The invention preferably uses optical glyphs pre-printed on the page to provide position information to the sensing means. The device may operate as a peripheral where the print head is controlled in response to the detected position. Alternatively, the print head may be triggered by print control data itself embedded in the optically detected glyph information. Applications range from graphic design “toys” to hybrid large format printers either in a handheld or printer form-factor.

### TECHNICAL FIELD

The present invention relates to methods and apparatus for portable printing. More particularly, although not exclusively, the present invention relates to hybrid devices which can function as both pointing and printing devices for personal computers.

### BACKGROUND ART

Printing is usually the final step in most computer-based design processes. At the present time, printing technologies are constrained by known printer hardware form-factors, which correspond to variants on servo-driven print heads passing over an accurately positioned printing surface. For large format printers this can result in high printer hardware costs given the size requirements and the need to preserve the accurate tolerance necessary for image fidelity and consistency over large printing areas. It would be a great advantage if consumers could print on large paper formats without using large format printers.

It is also apparent that, computer-based printing processes are generally not considered susceptible to artistic or creative input. The printing process is overwhelmingly a batch process whereby image data is sent to a printer and the physical result produced without any further user interaction. Although creatively constrained, this is presently an effective paradigm for printing.

With the commoditization of a large number of previously relatively high-cost technologies such as optical scanning and printing, it has been realized that many of these previously sophisticated technologies can now be used in low-cost consumer-oriented devices such as optical pointing devices, photo-quality printers and the like.

This has stimulated new ways of thinking about computer peripherals, in the present case, in those technologies related to printing. The present invention leverages on the present accessibility of such hardware while simultaneously extending the scope of printer functionality. To this end, the invention envisages a new form-factor for printers and a number of novel applications based thereon. It is also envisaged that the invention will provide a mechanism for simplifying paper handling in conventional printers and allow substantial compromises in the accuracy of in-printer paper handling and print head positioning.

It is an object of the invention to offer a hybrid device which can be used as a printing means in a free-form manner and over a wide range of print media formats without the usual mechanical constraints of known printers.

### DISCLOSURE OF THE INVENTION

In one aspect the invention provides for a hybrid printing device for printing on a surface, the device comprising a printing means adapted to print on the surface and a sensing means adapted to sense the position of the printing device in relation to positioning indicia located on the surface wherein the printing means is further adapted to be responsive to the detected position of the device in relation to the detected position.

In one embodiment, the hybrid printing device is handheld.

The handheld hybrid printing device may be connected to a printing control means by a wired, wireless, RF, Infra Red or similar link.

In a further embodiment, the hybrid printing device has a standard printer form-factor, wherein displacement of the printing means over the surface is controlled by motors responsive to a printing control means.

The movement of the printing means over the surface may follow a regular, random or sequential scanning pattern with the printing means being activated depending on the detected location of the sensing means and hence the printing means.

The printing control means is preferably a computer.

In a preferred embodiment, the positioning indicia, preferably correspond to glyphs which encode absolute or position on the page, said glyphs being optically imaged by the sensing means and thus the absolute position of the printing means determined on the page.

The position of the printing means is preferably used to control the operation of the printing means by switching the printing means on or off depending on whether the specific detected location on the surface is to be printing on.

In an alternative embodiment, the position of the sensing means, and hence the printing means, on the surface may be determined by a combination of absolute position detection based on optical glyphs located on the surface and detection of movement of the sensing means relative to the surface, thereby so long as at least one absolute position is detected by the sensing means, the time-varying absolute position of the sensing means may be determined by reference to that absolute position and the movement of the sensing means relative to that absolute position.

In one embodiment, the hybrid printing device can be configured with a paintbrush form-factor whereby a sweeping action of the device over the surface will result in printing occurring at designated locations on the surface.

The invention also provides for a method of printing on a surface, the method comprising the steps of detecting the absolute position of a printing means in relation to the surface and activating the printing means at designated locations on the surface as a function of the detected absolute position on that surface.

In a preferred embodiment, the printing control means remembers at which locations on the surface have already been printed on thus if movement of the hybrid device over the surface is interrupted, it may be continued without double printing or over-printing.

In a further embodiment, the glyph pattern may be printed on the paper prior to use with the handheld hybrid device.

### BRIEF DESCRIPTION OF THE DRAWINGS

The present invention will now be described by way of example only and with reference to the drawings in which:

FIG. 1: illustrates a side cross-section view of an embodiment of the invention in the form of a printing mouse; and

FIG. 2: illustrates a cutaway top view of a printing mouse.

### BEST MODE FOR CARRYING OUT THE INVENTION

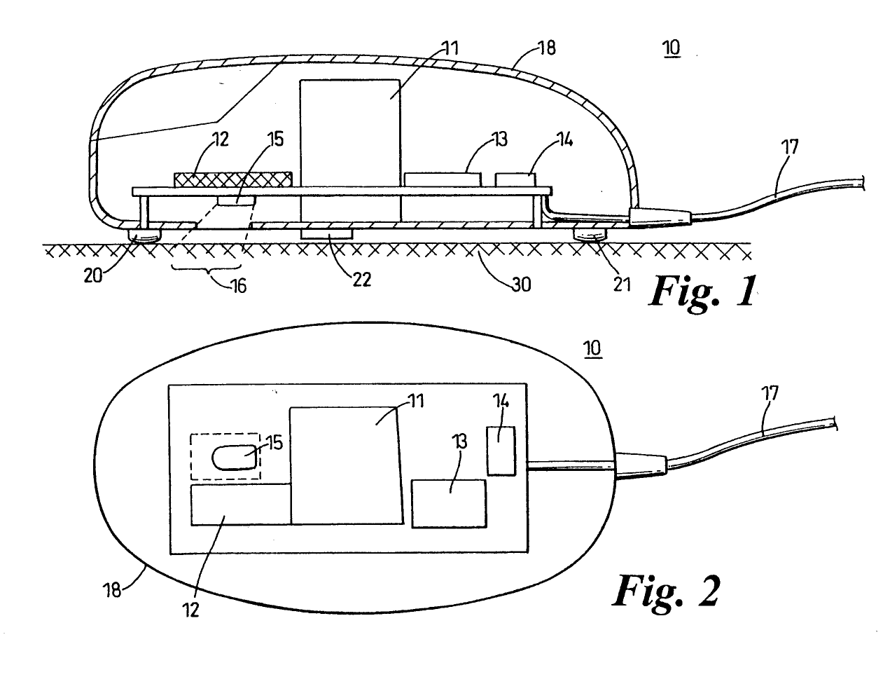

The operation of the invention can be explained with reference to the embodiment illustrated in FIGS. 1 and 2. Superficially, the device resembles a conventional mouse and is referred to as a “printing mouse”.

The embodiment shown in FIGS. 1 and 2 will be described with reference to a position sensing system which uses optically imaged position-encoding glyphs printed on the printing surface. This is referred to generally as a “glyph bed” and provides a means of encoding absolute position data on the paper to the resolution of the particular glyph encoding system which is used. This will be discussed in detail where necessary. However, it is to be understood that there are a number of ways of detecting the absolute position of a device, such as print head, on a surface. These include electromagnetic position sensing systems and triangulation techniques to name two.

The absolute position of the mouse is determined by sensing the glyph on the print surface. The glyphs are imaged by an optical sensor in the hybrid printed device and converted into absolute position data.

For a complete discussion of an example of such a technique, the reader is referred to International Patent Number WO 0126032 A1 the disclosure of which is incorporated by reference.

Referring to the Figures, a hybrid printing device (“printing mouse”) 10 is shown in cross-section. The mouse has a conventional body 18, buttons and wire connection 17. The mouse is shown resting on a printing surface 30. The printing surface 30 will usually be a sheet of paper.

The position of the mouse 10 is determined as follows. The surface 30 has printed thereon a ‘bed’ of position-encoding glyphs (not shown). These can be thought of as optically readable tags which uniquely identify positions on the surface. The glyphs may also be used to encode digital information, including print head control commands, onto the paper.

WO 0126032 A1 describes a method by which glyphs are arranged on a surface. According to this example, each glyph is a dot arranged in one of four orthogonal positions around a nominal position. This combination is called a “mark”. For each mark, the orientation of the dot in relation to the nominal position defines the data value for that glyph. The nominal positions define a virtual grid which is visible by detecting an array of marks. Four mark values (1,2,3,4) are used to define corresponding x and y code values. In this way two completely independent bit patterns can be obtained by means of the glyph pattern. The position code is constructed using a four-bit cyclic bit series of ones and zeroes. To code the coordinates, the bit series is written sequentially in columns. The coding is based on differences between adjacent bit series in adjacent columns.

Such a technique, when using glyph groups comprising six by six marks, provides the ability to theoretically encode 4³⁶ positions. At a virtual grid dimension of 0.3 mm, this corresponds to an extremely large surface. Thus each individual sheet carrying such a glyph bed can be virtually uniquely identified. This is done using some type of page location lookup functionality. However in the context of the present invention, the efficiency and information density capabilities of the glyph pattern need only to be able to take into account the size of any anticipated printed page or sheet. However, unique page identification may be implemented for certain applications.

In practice, using this position encoding technique, the glyph bed appears as a grey background on the surface and therefore does not interfere significantly with the appearance of the surface.

The absolute mouse position is determined by capturing the region of the glyph bed in the field of view of the mouse, correcting it for parallax if necessary, correcting for mouse rotation and decoding the glyph pattern. Thus a continuous determination of the mouse absolute position and orientation of the mouse on the surface can be made.

The printing mouse 10 includes an imaging means 15 which illuminates an area denoted by the numeral 16 and detects the light reflected therefrom. The device also includes associated support circuitry 12 for driving the imaging system and processing the raw optical data received from the detector. In the embodiment shown, the imaging means also includes a solid state detector for capturing images of the illuminated portion of the glyph bed. The imaging means “looks at” the surface and determines the position and orientation of the mouse on the surface based on knowledge of the orientation of the glyph bed on the page combined with rotational corrections and the decoded glyph position data. The (x, y, orientation) data is transmitted to a printing control means in the PC (not shown).

The mouse 10 also includes printer hardware 11 including a print head 22. The print head 22 is responsive to print commands received by the processor 12. Memory 13 is included to allow for buffering of position/print information and a communication interface is shown by the numeral 14. Communication between the mouse and the computer may be by means of wired, wireless, optical means or equivalent and may implement any convenient standard such as Bluetooth for wireless or USB for a cabled connection.

A sensor (not shown) may also be included for detecting when the mouse is placed on the printable surface. This is a microswitch or a proximity sensor based on optics or ultrasound. This component is used to switch the printing head on and off and to provide a signal which records when the mouse is printing on the page. This allows the user to raise and lower the mouse repeatedly as one would in a natural ‘painting’ action while not overprinting previously printed areas and printing on blank areas.

The operation of the printing mouse is predicated on the user performing a printing operation on the surface. To this end, the user would normally specify the size of surface which is to be printed on and the graphical content of the printing task. There may also be various initialization steps which specify the paper size etc.

By way of example, it is assumed that a user has created a printable image on glyph-enabled paper using a graphic design or word processing application. This could be a well known existing applications such as MSPaint, Word or similar. Alternatively, an application could be written specifically to take advantage of the features of the present invention. An example of such a specialized application might be one developed for children whereby a user could design the printed image on the PC using simple brush-like design tools. The child would then “paint” the image onto the position-encoded paper by sweeping the mouse over the printable surface while maintaining the mouse in contact with the printable surface.

Printing mouse control is handled by the printing control means (not shown). The system needs to be able to recognize the position-encoded paper and the user may use a pre-printed sheet of glyph-enabled paper. Alternatively, the user may print a glyph-enabled “blank” using his or her PC and printer.

As the mouse is passed over the paper the microswitch detects when the mouse is in contact with the printable surface. When the mouse is in contact with the paper, the system determines the mouse position and orientation and commands the print head to switch on and off as required to build up the image on the page. The head switching can also be controlled as a function of the mouse orientation as well as taking into direction the stroke direction of the mouse sweep.

In an alternative embodiment, the glyph information on the pre-printed page may itself contain the instructions and commands to trigger the print head. In this manner the page acts as if it carried “invisible ink” which becomes active when the mouse is passed over it. Here, there is no need for a printing PC-based control system as the mouse is completely responsive to the print commands it encounters embed in the glyph pattern as it sweeps over the page. This embodiment may be refined so that the mouse “remembers” where on the page it has printed to avoid overprinting etc.

In more sophisticated embodiments, there may be some degree of control from a printing control system. For example, the page might include embedded commands for activating particular colors which are defined by the user using a graphical design application. An example of this is a “magic painting toy”. This is a mouse acting as an invisible ink brush which, when passed over the paper, causes the pattern to “appear”. Such a device could be entirely self-contained and would respond solely to the position and print command information encoded into the glyphs on the page.

This embodiment may have other applications beyond that mentioned above such as creative or artistic applications as well as instructional. Such embodiments are to be considered within the scope of the invention.

In a further more technical embodiment, the system may be implemented in a traditional form-factor printer. However in this case, pages carrying pre-printed glyphs are passed through a printer whereby the print head incorporates a scanning device which detects where on the page it is located as a function of time. A feedback mechanism operates to trigger the print head as it passes over print areas. This is useful for large format printers as this avoids the need for accurate print head positioning as the positioning function is carried out by optically detecting the position of the print head relative to the pre-printed glyph-bed. The print head is scanned across the page and the print head triggered at the appropriate place in order to build up the image. This technique could be also modified to take into account or calculate an optimized scanning or printing pattern to minimize the area traversed by the print head and therefore the time taken to complete the print task.

The invention relies on the ability to accurately encode position into a printable media. While the particular example discussed above has focused on optical sensing ofposition, there are a number of other techniques which may be used and are discussed elsewhere in the literature. In particular, triangulation methods using electromagnetic, optical or acoustic techniques may be feasible. Also, other optical techniques, which couple the accurate detection of relative movement of an optical sensor, may be combined with absolute measurements of the sensor position. This avoids problems where glyphs are obscured by previously inked areas thereby interfering with the position detection step. This method is discussed in applicants copending patent application Ser. No. ______.

As seen from above, the invention offers an entirely new paradigm for printing using hybrid printing devices which have unusual and flexible form-factors compared to traditional printing systems. Suitable uses range from low-level consumer devices to relatively sophisticated high end printing systems. Notably, the device may also be used as a pointing device when used in conjunction with a suitable glyph-enabled mouse surface.

Although the invention has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A hybrid printing device for printing on a surface, the device comprising:
a printing means adapted to print on the surface; and
a sensing means adapted to sense the position of the printing device in relation to positioning indicia located on the surface wherein the printing means is further adapted to be responsive to the detected position of the device in relation to the detected position.

2. A hybrid printing device as claimed in claim 1 having a handheld form-factor.

3. A hybrid printing device as claimed in claim 1 wherein the device is connected to a printing control means by a wired, wireless, RF or Infra Red link.

4. A hybrid printing device as claimed in claim 1 wherein the positioning indicia encode data describing absolute or relative positions on the surface, said indicia being optically imaged by the sensing means and thus providing an output representing the absolute position of the printing means the surface.

5. A hybrid printing device as claimed in claim 1 wherein the position of the printing means is used to control the operation of the printing means by switching the printing means on or off depending on whether the specific detected location on the surface is to be printing on.

6. A hybrid printing device as claimed in claim 1 wherein the position of the sensing means, and hence the printing means, on the surface is determined by a combination of absolute position detection based on optical glyphs located on the surface and detection of movement of the sensing means relative to the surface, thereby, so long as at least one measurement of the absolute position is performed by the sensing means, the time-varying absolute position of the sensing means may be determined by reference to that absolute position and the movement of the sensing means relative to that absolute position.

7. A hybrid printing device as claimed in claim 1 wherein the hybrid printing device is configured with a paintbrush form-factor whereby a sweeping action of the device over the surface will result in printing at designated locations on the surface.

8. A hybrid printing device as claimed in claim 1 wherein the hybrid printing device has a printer form-factor and wherein the operation of the printing means is controlled by reference to data embedded in the indicia.

9. A hybrid printing device as claimed in claim 8 wherein movement of the printing means over the surface follows a regular, random or sequential scanning pattern with the printing means being activated depending on the detected location of the sensing means and hence the printing means.

10. A hybrid printing device as claimed in claim 9 wherein the movement of the printing means is optimized depending on the print control data embedded in the indicia.

11. A hybrid printing device as claimed in claim 1 wherein the printing control means is a computer.

12. A method of printing on a surface, the method comprising the steps of detecting the absolute position of a printing means in relation to the surface and activating the printing means at designated locations on the surface as a function of the detected position on that surface.

13. A method of printing on a surface as claimed in claim 12 wherein a printing control means remembers at which locations on the surface have already been printed on, thereby allowing the movement of the hybrid device over the surface to be interrupted.

14. A hybrid printing device as claimed in claim 1 wherein the indicia pattern are printed on the surface prior to use with the handheld hybrid printing device.

15. A hybrid printing device as claimed in claim 1 wherein the hybrid printing device is responsive to printing commands encoded on or into the surface whereby the hybrid device prints on the surface as it is passed over the surface in a manner which is controlled by the data contained in the area of the printing surface which is imaged by the device.
